(19) United States
(12) Patent Application Publication
(10) Pub. No.: US 2026/0365571 A1
(43) Pub. Date: Nov. 19, 2026

(54) BOROSILICATE GLASS WITH MODIFIED SURFACE LAYER

(71) Applicant: CORNING INCORPORATED, CORNING, NY (US)

(72) Inventors: Charles Thomas McLaren, Elmira, NY (US); Mardochee Reveil, Stockbridge, GA (US); Nicholas James Smith, Port Matilda, PA (US); Adama Tandia, Corning, NY (US)

(21) Appl. No.: 19/133,460

(22) PCT Filed: Nov. 20, 2023
(86) PCT No.: PCT/US2023/080485

§ 371 Date: May 28, 2025

Related U.S. Application Data
(60) Provisional application No. 63/428,767, filed on Nov. 30, 2022.

(51) Int. Cl. C03C 23/00; C03C 3/089

(52) U.S. Cl. CPC C03C 23/009; C03C 3/089; C03C 23/007

(57) ABSTRACT

A glass substrate includes an alkali-containing bulk and an alkali-depleted surface layer. The alkali-depleted surface layer is amorphous and comprises a substantially homogenous composition. The alkali-containing bulk and the alkali-depleted surface layer comprise B₂O₃ and SiO₂. A method for forming a glass substrate with a modified surface layer includes providing a glass substrate with a concentration of alkali, a glass transition temperature (Tg), and a surface layer. The glass substrate further comprises B₂O₃ and SiO₂. The method further includes reducing the concentration of alkali in the surface layer such that the surface layer with reduced concentration of alkali comprises a substantially homogenous composition.

### CROSS-REFERENCE To RELATED A PLICATIONS

This application claims the benefit of priority under 35 U.S.C. § 119 of U.S. Provisional Application No. 63/428,767 filed Nov. 30, 2022, the content of which is incorporated herein by reference in its entirety.

### FIELD

The disclosure relates to glass substrates with a modified surface layer and, more particularly, to glass substrates with an alkali-containing bulk and an alkali-depleted surface layer.

### BACKGROUND

Glasses formed or treated using known surface treatment (e.g., including melt-prepared glasses) often include surface layers that are at least partially crystallized or include crystallized portions, or may exhibit phase separation (i.e., a nonhomogeneous composition). In other known methods used to modify surface layers (e.g., leaching or wet chemical treatments), the resulting surface layer includes hydrogen, which may be present in the form of H⁺, H₃O⁺, H₂O or combinations thereof.

Thermal poling has been utilized to modify the properties of glass. Thermal poling generally involves the application of voltage to a glass. Known uses of thermal poling include the formation of depletion layers that inhibit alkali migration in photovoltaic glasses, the formation of interfacial barrier layers between display (or alkali-free) glass and silicon, and the formation of surface texture or selective-area ion exchange with patterned electrodes.

Thermal poling has also been used to induce second-order nonlinear properties, especially second-order nonlinear optical properties, for the purpose of creating optical switches and devices. Poling methods are also closely analogous to so-called anodic bonding, which is applied to bond alkali-containing or alkali-free glasses to other materials, especially semiconductors.

The instant disclosure provides glass substrates having a variety of compositions in the borosilicate and alumninoborosilicate families and a surface layer with a modified composition and atomic structure. In embodiments, the surface layer has a reduced concentration of alkali, while the bulk of the glass substrate includes alkali. The surface layer includes an atomic structure with substantially all boron in the 3-coordinated state whereas the bulk has an atomic structure with most of the boron in the 4-coordinated state. The composition and atomic structure of the surface layer enable various surface properties and performance attributes of the glass substrate. For example, the surface layer can be used to improve the corrosion resistance, diffusion barrier, hardness, elastic modulus, fatigue resistance and damage resistance (e.g. anomalous deformation) of the glass substrate.

### SUMMARY

According to aspect (1), a glass substrate is provided. The glass substrate comprises: an alkali-containing bulk; and an alkali-depleted surface layer, wherein the alkali-depleted surface layer is amorphous and comprises a substantially homogenous composition, and wherein the alkali-containing bulk and the alkali-depleted surface layer comprise B₂O₃ and SiO₂.

According to aspect (2), the glass substrate of aspect (1) is provided, wherein the alkali-depleted surface layer comprises about 0.5 atomic % alkali or less.

According to aspect (3), the glass substrate of aspect (1) or aspect (2) is provided, wherein the alkali-depleted surface layer comprises an atomic structure comprising boron substantially in a 3-coordinated state.

According to aspect (4), the glass substrate of aspect (3) is provided, wherein greater than about 60% by fraction of a total amount of boron in the alkali-depleted surface layer is in a 2-coordinated state.

According to aspect (5), the glass substrate of aspect (3) is provided, wherein greater than about 70% by fraction of a total amount of boron in the alkali-depleted surface layer is in a 3-coordinated state.

According to aspect (6), the glass substrate of aspect (3) is provided, wherein greater than about 75% by fraction of a total amount of boron in the alkali-depleted surface layer is in a 3-coordinated state.

According to aspect (7), the glass substrate of any one of aspects (1)-(6) is provided, wherein the alkali-containing bulk comprises an atomic structure comprising boron in a 3-coordinated state and boron in a 4-coordinated state.

According to aspect (8), the glass substrate of aspect (7) is provided, wherein greater than about 51% by fraction of a total amount of boron in the alkali-containing bulk is in a 4-coordinated state.

According to aspect (9), the glass substrate of any one of aspects (1)-(8) is provided, wherein the alkali-depleted surface layer is substantially free of non-bridging oxygens.

According to aspect (10), the glass substrate of aspect (9) is provided, wherein the alkali-containing bulk comprises non-bridging oxygens and bridging oxygens.

According to aspect (11), the glass substrate of aspect (10) is provided, wherein the alkali-containing bulk is substantially free of non-bridging oxygens.

According to aspect (12), the glass substrate of any one of aspects (1)-(11) is provided, wherein the alkali-containing bulk comprises an alkali-metal oxide selected from Li₂O, Na₂O, K₂O, Rb₂O and Cs₂O.

According to aspect (13), the glass substrate of aspect (12) is provided, wherein the alkali-containing bulk comprises at least 1 mol % Na₂O, K₂O, or Li₂O.

According to aspect (14), the glass substrate of aspect (12) is provided, wherein the alkali-containing bulk comprises at least 1 mol % Na₂O.

According to aspect (15), the glass substrate of any one of aspects (1)-(14) is provided, wherein the alkali-depleted surface layer comprises B₂O₃ in the range from about 10 mol % to about 90 mol %.

According to aspect (16), the glass substrate of any one of aspects (1)-(15) is provided, wherein the alkali-depleted surface layer comprises a binary B₂O₃—SiO₂ composition.

According to aspect (17), the glass substrate of any one of aspects (1)-(16) is provided, wherein atomic % silicon is greater than atomic % boron.

According to aspect (18), a glass substrate is provided. The glass substrate comprises: a substrate thickness; an alkali-containing bulk having a bulk refractive index; and an alkali-depleted surface layer comprising a layer thickness in a range of from about 10 nm to about 3000 nm, wherein the alkali-depleted surface layer comprises a layer refractive index that is less than the bulk refractive index, wherein the alkali-containing bulk and the alkali-depleted surface layer comprise B₂O₃ and SiO₂.

According to aspect (19), the glass substrate of aspect (18) is provided, wherein atomic % silicon is greater than atomic % boron.

According to aspect (20), a method of forming a glass substrate with a modified surface layer is provided. The method comprises: providing a glass substrate comprising a concentration of alkali, a glass transition temperature (Tg) and a surface layer, the glass substrate comprising B₂O₃ and SiO₂ and reducing the concentration of alkali in the surface layer, wherein the surface layer with reduced concentration of alkali comprises a substantially homogenous composition.

According to aspect (21), the method of aspect (20) is provided, wherein atomic % silicon is greater than atomic % boron.

According to aspect (22), the method of aspect (20) or aspect (21) is provided, wherein reducing the concentration of alkali in the surface layer comprising contacting a surface of the glass substrate with an electrode; and subjecting the glass substrate to thermal poling.

According to aspect (23), the method of aspect (22) is provided, wherein the electrode comprises an anode in contact with an anodic surface of the glass substrate and a cathode in contact with the cathodic surface of the glass substrate, and wherein thermal poling comprises applying voltage to the glass substrate such that the anode is positively biased relative to the glass substrate to induce alkali depletion at the anodic surface of the glass.

According to aspect (24), the method of aspect (22) is provided, wherein thermal poling comprises heating the glass substrate and electrode to a temperature below Tg prior to applying voltage to the glass substrate.

According to aspect (25), the method of aspect (22) is provided, wherein thermal poling comprises applying voltage in the range from about 100 volts to about 10,000 volts to the glass substrate for a duration in the range from about 1 minute to about 6 hours.

According to aspect (26), the method of aspect (22) is provided, wherein the glass substrate is subjected to thermal poling under vacuum, in an inert gas environment, or a permeable gas environment.

### BRIEF DESCRIPTION OF THE DRAWINGS

FIG. 1 is a side view of a glass substrate according to embodiments;

FIG. 2A is a ternary diagram of precursor glasses of Example 1;

FIG. 2B shows the ternary diagram of FIG. 2A with network-former-only compositions formed by thermal poling the precursor glasses of the Example 1 projected onto the B₂O₃—SiO₂ binary edge of the diagram;

FIGS. 3-7 show secondary-ion-mass-spectrometry (SIMS) depth profiles for certain elements through alkali-depleted surface layers of select glasses of Example 1 after thermal poling;

FIG. 8 is a bar chart summarizing results of near-edge X-ray absorption fine-structure (NEXAFS) spectroscopy for select glasses of Example 1 after thermal poling;

FIG. 9 is a group of line charts reporting molecularly simulated change in coordination state of boron after thermal poling different alkali and alkaline-earth borosilicate precursor glasses; and

FIG. 10 is a group of line charts reporting molecularly simulated change in Young's modulus after thermal poling the different alkali and alkaline-earth borosilicate precursor glasses of FIG. 9.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles disclosed herein as would normally occur to one skilled in the art to which this disclosure pertains

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone: B alone: C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein, unless defined elsewhere in association with specific terms or phrases, are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom, above, below, and the like—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, the terms “atom %,” “atomic %,” or “atomic-%” refer to a glass composition in terms of molar percentage proportions of individual elements, such as O, Si, Al, B, Na, Ca, etc. By convention, oxide glasses may also be described in terms of proportions of component oxides, each with some assumed oxygen stoichiometry, such as SiO₂, Al₂O₃, B₂O₃, Na₂O, CaO, etc. As used herein, the terms “mol %,” “mole %,” or “molar-%” describe a glass composition in terms of molar percentage proportions of component oxides. The terms “wt %” or “weight-%” describe a glass composition in terms of mass percentage proportions of component oxides. Elements may be interchangeably referred to by their name or symbol (e.g., carbon or C, oxygen or O, etc.).

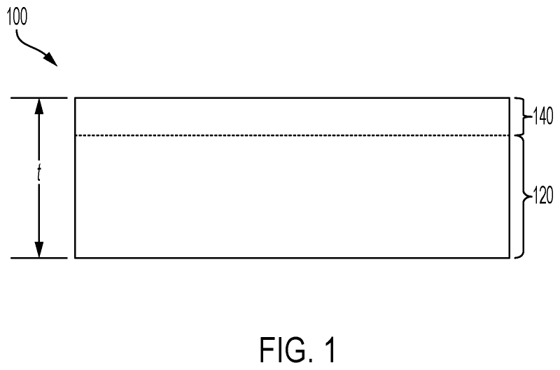

As shown in FIG. 1, a first aspect of this disclosure pertains to a glass substrate 100 including an alkali-containing bulk 120 (interchangeably referred to as “bulk”) and an alkali-depleted surface layer 140. The alkali-containing bulk may include one or more alkali-metal oxides selected from Li₂O, Na₂O, K₂O, Rb₂O and Cs₂O. In embodiments, the alkali-depleted surface layer may be substantially alkali-free or alkali free. For example, the alkali-depleted surface layer can comprise about 0.5 atomic % alkali or less. The alkali-depleted surface layer may be described as a borosilicate (i.e., atomic % silicon>atomic % boron) surface layer or a boroaluminosilicate surface layer (i.e., atomic % silicon>[atomic % boron+atomic % aluminum]). The alkali-depleted surface layer exhibits a composition and atomic structure that differs from the bulk, while exhibiting homogeneity in terms of composition and/or atomic structure within and throughout the surface layer. The alkali-depleted surface layer is integral to the glass substrate and is not a coating or an addition to the bulk.

In embodiments, the glass substrate may have a substrate thickness t in a range of from about 0.1 mm to about 3.0 mm, from about 0.3 mm to about 3 mm, from about 0.4 mm to about 3 mm, from about 0.5 mm to about 3 mm, from about 0.55 mm to about 3 mm, from about 0.7 mm to about 3 mm, from about 1 mm to about 3 mm, from about 0.1 mm to about 2 mm, from about 0.1 mm to about 1.5 mm, from about 0.1 mm to about 1 mm, from about 0.1 mm to about 0.7 mm, from about 0.1 mm to about 0.55 mm, from about 0.1 mm to about 0.5 mm, from about 0.1 mm to about 0.4 mm, from about 0.3 mm to about 0.7 mm, or from about 0.3 mm to about 0.55 mm, and also comprising all sub-ranges and sub-values between these range endpoints.

In embodiments, the alkali-depleted surface layer may have a layer thickness in a range of from about 10 mu to about 3000 nm, from about 10 nm to about 2000 nm, from about 10 nm to about 1000 nm, from about 10 nm to about 900 nm, from about 10 nm to about 800 nm, from about 10 nm to about 700 n, from about 10 nm to about 600 nm, from about 10 nm to about 500 nm, from about 50 nm to about 1000 nm, from about 100 nm to about 1000 nm, from about 200 nm to about 1000 nm, from about 250 nm to about 1000 nm, from about 300 nm to about 1000 nm, from about 400 nm to about 1000 nm, from about 500 nm to about 1000 nm, from about 500 nm to about 1500 nm, from about 500 nm to about 2000, from about 500 nm to about 2500 nm, or from about 500 nm to about 3000 nm.

In embodiments, the alkali-depleted surface layer has a substantially homogenous composition. In embodiments, the composition of the alkali-depleted surface layer is substantially the same along the layer thickness of the surface layer. In embodiments, the composition of the alkali-depleted surface layer is substantially the same along its entire volume. As used herein, the phrase “homogenous composition” refers to a composition that is not phase separated and/or does not include portions with a composition differing from other portions.

In embodiments, the alkali-depleted surface layer may be substantially free of crystallites and/or is substantially amorphous. For example, the alkali-depleted surface layer can include less than about 1 volume % crystallites.

In embodiments, the alkali-depleted surface layer is substantially free of hydrogen. Such hydrogen may be present in the form of H⁺, H₃O⁺, H₂O or combinations thereof. In embodiments, the alkali-depleted surface layer includes about 0.1 atomic % hydrogen or less (e.g., about 0.08 atomic % hydrogen or less, about 0.06 atomic % hydrogen or less, about 0.05 atomic % hydrogen or less, about 0.04 atomic % hydrogen or less, about 0.02 atomic % hydrogen or less, or about 0.01 atomic % hydrogen or less). In contrast, glass substrates that are treated by leaching or other wet chemical treatments typically have surface layers that include hydrogen.

In alternative embodiments, the alkali-depleted surface layer may have hydrogen injected into its composition under certain thermal poling conditions. For example, under conditions in which thermal poling occurs in air, the alkali-depleted surface layer may include hydrogen in amount greater than that indicated in the paragraph immediately above.

In embodiments, the alkali-containing bulk and the alkali-depleted surface layer comprise B₂O₃ and SiO₂. The alkali-containing bulk and the alkali-depleted surface layer each have an atomic structure that comprises boron in one or more coordination states.

In embodiments, the alkali-depleted surface layer includes boron in the 3-coordinated state (interchangeably referred to as trigonal B[3] units or simply B[3]) and boron in the 4-coordinated state (interchangeably referred to as tetrahedral B[4] units or simply B[4]). In embodiments, substantially all the boron in the alkali-depleted surface layer is in the 3-coordinated state. In embodiments, most of the boron in the alkali-depleted surface layer is in the 3-coordinated state. For example, from about 55% to about 100% by fraction (e.g., from about 60% to about 100%, from about 65% to about 100%, from about 70% to about 100%, from about 75% to about 100%, from about 75% to about 95%, from about 80% to about 100%, and comprising all sub-ranges and sub-values between these range endpoints) of a total amount of boron in the alkali-depleted surface layer is in in the 3-coordinated state. Conversely, less than about 45% by fraction (e.g., less than about 40%, less than about 35%, less than about 30%, less than about 25%, less than about 20%, less than about 15%, less than about 10%, less than about 5%, or less than about 2.5%) of a total amount of boron in the alkali-depleted surface layer is in in the 4-coordinated state.

In embodiments, the alkali-containing bulk includes boron in the 3-coordinated state and boron in the 4-coordinated state. In embodiments, a majority (i.e., an amount greater than half of the total) of the boron in the alkali-containing bulk is in the 4-coordinated state. For example, from about 51% to about 100% by fraction (e.g., from about 55% to about 100%, from about 60% to about 100%, from about 65% to about 100%, from about 70% to about 100%, from about 70% to about 95%, from about 80% to about 100%, and comprising all sub-ranges and sub-values between these range endpoints) of a total amount of boron in the alkali-containing bulk is in in the 4-coordinated state.

In some instances, the alkali-depleted surface layer is substantially free of non-bridging oxygens, while, in some embodiments, the alkali-containing bulk comprises non-bridging oxygens and bridging oxygens. An alkali-depleted surface layer may also be present or formed when the alkali-containing bulk is substantially free of non-bridging oxygens.

In embodiments, the alkali-depleted surface layer comprises B₂O₃ in a range of from about 1 mol % to about 90 mol %. In embodiments, the amount of B₂O₃ may be in the range from about 1 mol % to about 80 mol %, from about 1 mol % to about 70 mol %, from about 1 mol % to about 60 mol %, from about 1 mol % to about 50 mol %, from about 5 mol % to about 90 mol %, from about 10 mol % to about 90 mol %, from about 20 mol % to about 90 mol %, from about 30 mol % to about 90 mol %, from about 1 mol % to about 55 mol %, 5 mol % to about 45 mol %, or from about 3 mol % to about 35 mol %.

In exemplary embodiments, the alkali-depleted surface layer comprises a binary B₂O₃—SiO₂ composition, though other non-alkali components may be included.

The glass substrate, prior to thermal poling treatment, as will be described herein, and the alkali-containing bulk may include a variety of glass compositions. Such glass compositions used in the glass substrate prior to thermal poling treatment and present in the alkali-containing bulk after thermal poling treatment may be referred to herein as a “precursor” glass or glass composition. The precursor compositions may range from simple alkali or alkaline-earth silicates, borosilicates, or boroaluminosilicates, to more complex multicomponent glasses able to form an altered surface layer by the process of thermal poling. In one embodiment, the alkali-containing bulk may show signs of nanoscale phase-separation but, when these glasses were subjected to thermal poling, the layers included a single-phase.

In embodiments, the precursor glass composition is configured to form a homogeneous glass (i.e., not phase-separated, not devitrified).

In embodiments, the precursor glass composition comprises some alkali. For example, the precursor glass composition comprises greater than or equal to 1 mol % alkali-metal oxide selected from Li₂O, Na₂O, K₂O, Rb₂O, and Cs₂O. In an exemplary embodiment, the precursor glass composition comprises greater than or equal to 1 mol % Na₂O. For example, the precursor glass composition can comprise greater than or equal to, 1.5, 2, 3, 4, 5, 6, 7, 8, 9, or 10 mol % Na₂O.

In embodiments, the precursor glass composition comprises some boron. For example, the precursor glass composition comprises greater than or equal to 1 mol % B₂O₃. In embodiments, the precursor glass composition can comprise greater than or equal to 1, 1.5, 2, 3, 4, 5, 6, 7, 8, 9, 10, 15, or 20 mol % B₂O₃.

In embodiments, the precursor glass composition is a simple sodium borosilicate that comprises Na₂O, B₂O₃, and SiO₂. In one example, the precursor glass composition comprises from about 8.5 mol % to about 43 mol % Na₂O, from about 9 mol % to about 87 mol % B₂O₃, and from about 9.5 mol % to about 88 mol % SiO₂. In another example, the precursor glass composition comprises from about 9.5 mol % to about 39 mol % Na₂O, from about 10 mol % to about 79.5 mol % B₂O₃, and from about 10.5 mol % to about 80 mol % SiO₂.

In embodiments, there is a relationship between the amounts of silicon and boron that follows: atomic % silicon>atomic % boron. For example, the precursor glass composition comprises from about 8.7 mol % to about 21.5 mol % Na₂O, from about 9 mol % to about 33 mol % B₂O₃, and from about 54 mol % to about 88 mol % SiO₂. In another example, the precursor glass composition comprises from about 9.5 mol % to about 19.5 mol % Na₂O, from about 10 mol % to about 30 mol % B₂O₃, and from about 60 mol % to about 80 mol % SiO₂.

In embodiments, the precursor glass composition is an alkali-containing borosilicate, an alkali-containing boroaluminosilicate, or a combination thereof. In such embodiments, there is a relation in which the amount of silicon is greater than the amount of amount of boron alone, the amount of aluminum alone, or the combined amounts of boron and aluminum (e.g., atomic % silicon>[atomic % aluminum+atomic % boron]). In embodiments, the amount of alkali may be limited such that there is no invert glass with more alkali than network-former. In such embodiments, there is a relationship among the amounts of alkali, aluminum, boron, and silicon that follows: atomic % alkali<(atomic % silicon atomic % aluminum+atomic % boron).

In an exemplary embodiment, the precursor glass composition comprises from about 46 mol % to about 80 mol % SiO₂, from about 0 mol % to about 17 mol % Na₂O, from about 8 mol % to about 25 mol % Al₂O₃, from about 2 mol % to about 15 mol % B₂O₃, from about 0 mol % to about 8 mol % MgO, from about 0 mol % to about 5 mol % K₂O from about 0 mol % to about 11 mol % CaO, and from about 0.05 mol % to about 0.5 mol % SnO₂.

In another exemplary embodiments, the precursor glass composition comprises from about 57 mol % to about 67 mol % SiO₂, from about 1 mol % to about 14 mol % Na₂O, from about 11 mol % to about 21 mol % Al₂O₃, from about 3 mol % to about 10 mol % B₂O₃, from about 0 mol % to about 5 mol % MgO, from about 0 mol % to about 3 mol % K₂O, from about 0 mol % to about 8 mol % CaO, and from about 0.05 mol % to about 0.25 mol % SnO₂.

In embodiments, the precursor glass composition may be substantially free of aluminum. For example, the precursor glass composition and/or the glass substrate after thermal poling treatment may include less than about 1 mol %, or less than about 0.1 mol % Al₂O₃ or aluminum in any state.

In embodiments, the alkali-containing bulk may include an amount of Na₂O that is about equal to the amount of B₂O₃ present in the bulk.

Fining agents may be included in the precursor glass compositions described herein such as SnO₂ and other known fining agents.

In embodiments, the glass substrate after thermal poling treatment exhibits a refractive index in the range from about 1.45 to about 1.55, with the alkali-depleted surface layer exhibiting a lower refractive index than the alkali-containing bulk.

In embodiments, the glass substrate may exhibit an average strain-to-failure at a surface on one or more opposing major surface that is 0.5% or greater, 0.6% or greater, 0.7% or greater, 0.8% or greater, 0.9% or greater, 1% or greater, 1.1% or greater, 1.2% or greater, 1.3% or greater, 1.4% or greater 1.5% or greater or even 2% or greater, as measured using ball-on-ring testing using at least 5, at least 10, at least 15, or at least 20 samples. In embodiments, the glass substrate may exhibit an average strain-to-failure at its surface on one or more opposing major surface of about 1.2%, about 1.4%, about 1.6%, about 1.8%, about 2.2%, about 2.4%, about 2.6%, about 2.8%, or about 3% or greater.

After thermal poling treatment, the glass substrates described herein may exhibit an elastic modulus (or Young's modulus) in a range of from about 30 GPa to about 120 GPa. For example, the elastic modulus of the glass substrate may be in a range of from about 30 GPa to about 110 GPa, from about 30 GPa to about 100 GPa, from about 30 GPa to about 90 GPa, from about 30 GPa to about 80 GPa, from about 30 GPa to about 70 GPa, from about 40 GPa to about 120 GPa, from about 50 GPa to about 120 GPa, from about 60 GPa to about 120 GPa, or from about 70 GPa to about 120 GPa, and all ranges and sub-ranges therebetween.

In embodiments, the glass substrate may be strengthened or non-strengthened. For example, thermal poling may be performed on strengthened glass substrates such that the alkali-depleted surface layer is formed on top of a compressive stress layer in the strengthened glass substrate.

The glass substrate may be substantially planar or sheet-like, although other embodiments may utilize a curved or otherwise shaped or sculpted substrate. The glass substrate may be substantially optically clear, transparent, and free from light scattering. In such embodiments, the glass substrate may exhibit an average total transmittance over the optical wavelength regime of about 85% or greater, about 86% or greater, about 87% or greater, about 88% or greater, about 89% or greater, about 90% or greater, about 91% or greater or about 92% or greater.

Additionally, or alternatively, the physical thickness of the glass substrate may vary along one or more of its dimensions for aesthetic and/or functional reasons. For example, the edges of the glass substrate may be thicker as compared to more central regions of the glass substrate. The length, width, and physical thickness dimensions of the glass substrate may also vary according to the application or use.

The glass substrate may be provided using various forming methods, which can include float glass processes and down-draw processes such as fusion draw and slot draw.

The resulting glass substrates including the alkali-containing bulk and alkali-depleted surface layer described herein exhibit improved corrosion resistance, improved diffusion barrier properties, higher hardness and/or elastic-modulus values, greater fatigue resistance, and/or improved damage resistance (via so-called anomalous deformation).

The glass network has a near-maximal degree of connectivity, which favors high hardness and/or modulus. The absence of mobile alkali or other network-modifiers means there are very limited pathways for ionic hopping conduction, translating to inhibited diffusion (aka diffusion barrier) properties. Likewise, the absence of mobile alkali or other network-modifiers will increase resistance to corrosion in chemistries that operate primarily by an ion-exchange mechanism (e.g., H⁺/H₃O⁺↔Na⁺), a prime example being acidic chemistries. Even in chemistries that do not operate primarily by an ion-exchange mechanism, the absence of non-bridging oxygen and high network connectivity is expected to lead to reduced network dissolution, for example in neutral of alkaline-pH chemistries (consider silica dissolution rates versus other multicomponent glasses in basic-pH). To those knowledgeable in the art, fatigue resistance and crack initiation are substantially worse in alkali-containing glasses as compared to materials like silica, and thus the alkali-depleted surface layer thus would be expected to show a lower fatigue parameter and high crack initiation threshold. Lastly, the indentation behavior has been structurally linked in glasses to well-connected networks that have a substantial amount of free volume. As the layers described in this disclosure are formed well below Tg, they are expected to be far from the melt-equilibrium structure one might otherwise obtain by melting, and thus likely contain substantial free volume, translating to expectation of anomalous deformation behavior and so-called native damage resistance.

In embodiments, the alkali-depleted surface layer comprises a layer refractive index that is less than a bulk refractive index of the alkali-containing bulk. For example, the alkali-depleted surface layer may have a refractive index that is in the range from about 1.45 to about 1.55 at a wavelength of about 550 nm. This result is of generally sufficient index contrast and thickness to produce a visible anti-reflection effect in the thermally poled glasses. Moreover, in the case of borosilicate glasses, the boron structural units are modified from tetrahedral B[4]units to trigonal B[3] units in the alkali-depleted surface layer. Trigonal B[3] units may correspond to lower glass density compared to their B[4] counterparts. This in turn, may further increase the refractive index contrast between poled and bulk material for borosilicates compared to aluminosilicate glasses.

In embodiments, the glass substrate having an alkali-containing bulk and an alkali-depleted surface layer may exhibit increased elastic modulus as compared to the alkali-containing bulk (or the glass substrate before the alkali-depleted surface layer is formed). For example, the glass substrate may have an elastic modulus that is about 10% greater than the elastic modulus of the alkali-containing bulk (or the glass substrate before the alkali-depleted surface layer is formed). For example, where the alkali-containing bulk (or the glass substrate before the alkali-depleted surface layer is formed) exhibits an elastic modulus of about 80 GPa, the glass substrate exhibits an elastic modulus of about 90 GPa.

In embodiments, the hardness of the glass substrates described herein is also greater than the hardness of the alkali-containing bulk. For example, the hardness of the glass substrate may be about 10% or even 20% greater than the hardness of the alkali-containing bulk (or the glass substrate before the alkali-depleted surface layer is formed). In one example, the hardness of the alkali-containing bulk (or the glass substrate before the alkali-depleted surface layer is formed) may be about 6 GPa, while the glass substrate exhibits a hardness of about 7 GPa, at indentation depths from about 0 mm to about 200 nm. Unless otherwise specified, the hardness values described herein refer to Vickers hardness.

In embodiments, the alkali-depleted surface layers also block ion diffusion either into the glass substrate or from the alkali-containing bulk to the alkali-depleted surface layer.

The glass substrates described herein may exhibit an increased chemical durability in terms of resistance to dissolution in acid, water, or base. In some examples, the glass substrate exhibits a decrease in dissolution rates in acid, water, or base of about 1.5 times or more or even about 10 times or more.

A second aspect of this disclosure pertains to a method of forming a glass substrate with a modified surface layer. The method includes providing a glass substrate comprising a concentration of alkali and a surface layer and reducing the concentration of alkali in the surface layer. In embodiments, the resulting surface layer with reduced concentration of alkali comprises a substantially homogenous composition.

In embodiments, reducing the concentration of alkali in the surface layer includes contacting a surface of the glass substrate with an electrode and subjecting the glass substrate to thermal poling.

Prior to thermal poling treatment, the surface of the glass substrate (and thus the surface layer) may be cleaned or treated to remove typical contamination that may accumulate after forming, storage and shipping. Alternatively, the glass substrate may be subjected to treatment immediately after forming to eliminate the accumulation of contamination.

The electrode used in thermal poling; may include an anode in contact with an anodic surface of the glass substrate and a cathode in contact with a cathodic surface of the glass substrate. The anodic surface is subjected to positive direct current (DC) bias while the cathodic surface is subject to negative DC bias.

In embodiments, the electrode material is substantially more conductive than the glass at the poling temperature to provide for field uniformity over the modified surface area. It is also desirable that the anodic electrode material be relatively oxidation resistant to minimize the formation of an interfacial oxide compound that could cause sticking of the glass to the template. Exemplary anodic electrode materials include noble metals (e.g., Au, Pt, Pd, etc.) or oxidation-resistant, conductive films (e.g., TiN and TiAlN).

The cathodic electrode material may also be conductive to likewise provide for field uniformity over the modified area. Exemplary materials for the cathodic electrode material include materials that can accept alkali ions from the glass, such as graphite. In embodiments, a physical cathodic electrode may not always be necessary to be brought into contact, due to surface discharge.

In embodiments, the electrode(s) are separate components that are brought into contact with the glass, and thus can be separated after processing without complex removal steps. Electrodes can generally comprise a bulk material, or take the form of a thin film, for example, a conductive thin film or coating that is deposited on the glass to serve as an electrode.

In embodiments, the electrode can generally cover all or only part of the surface and may be intermittent or patterned as desired. Patterning can be achieved by any of a variety of methods, such as lithographic techniques, mechanical machining, or otherwise.

The curvature and/or flatness of the glass and the electrode should be ideally matched to provide for reasonably intimate contact at the interface over the affected area. However, even if initial contact is not intimate, the electrostatic charge at the interface when voltage is applied will tend to pull the two surfaces into intimate contact as an inherent part of the method.

Thermal poling may include applying voltage to the glass substrate such that the anode is positively-biased relative to the glass substrate to induce alkali depletion at the anodic surface of the glass. The voltage may be DC voltage or DC-biased AC voltage. Prior to applying the voltage, the method may include heating the glass substrate and electrode (i.e., the stack including an anode/glass/cathode) to a temperature below Tg prior to applying voltage to the glass substrate. In embodiments, the glass substrate and electrode may be heated to a process temperature in the range from about 25 °C to about Tg, or from about 100 °C to about 300 °C. In embodiments, equilibrium at the desired process temperature may be useful in thermal poling to ensure temperature uniformity.

In embodiments, the thermal poling treatment includes applying voltage in the range from about 100 volts to about 10,000 volts (e.g., from about 100 volts to about 1000 volts) to the glass substrate for a duration in the range from about 1 minute to about 6 hours (e.g., from about 5 minutes to about 60 minutes or from about 15 minutes to about 30 minutes). It should be appreciated that thermal poling treatment tunes and voltages may vary depending on glass composition. In embodiments, the glass substrate is subjected to thermal poling under vacuum in an inert gas environment (e.g., dry N₂) or a permeable gas environment (e.g., He).

The voltage may be applied in either one or more discrete steps to achieve a maximum desired value, or ramped (or increased) in a controlled/current-limited manner up to the process voltage. Various approaches have the advantage of potentially circumventing thermal dielectric breakdown with the passage of too much current through the glass, especially with low-resistivity glasses, allowing for higher final poling voltages and possibly thicker surface layers. Alternatively, as breakdown strength varies with glass composition, surface condition, and ambient temperature, an “instant-on” strategy for applying voltage may also be tolerated under some conditions and could be desired for convenience.

After thermal poling treatment, the glass substrate may be cooled to a temperature in the range from about 25 °C to about 80 °C for subsequent handling. The voltage may be removed prior to cooling or after cooling.

In embodiments, an apparatus suitable for performing poling treatments can include any system that can simultaneously maintain heat and voltage to the glass/electrode stack in a controlled manner while avoiding practical problems such as leakage current paths or arcing. In embodiments, the apparatus also provides control of the process atmosphere (e.g. under vacuum, in an inert gas environment such as dry N₂, or permeable gas environment), which can minimize atmosphere effects and/or occluded gas at the interface. An example apparatus suitable for performing thermal poling treatments is disclosed in U.S. Provisional Patent Application Ser. No. 63/193,334, filed on Mar. 21, 2022, the disclosure of which is incorporated herein by reference in its entirety.

### EXAMPLES

Various embodiments of the present disclosure can be better understood by reference to the following Example which is offered by way of illustration. The present disclosure is not limited to the Example given herein.

### Example 1

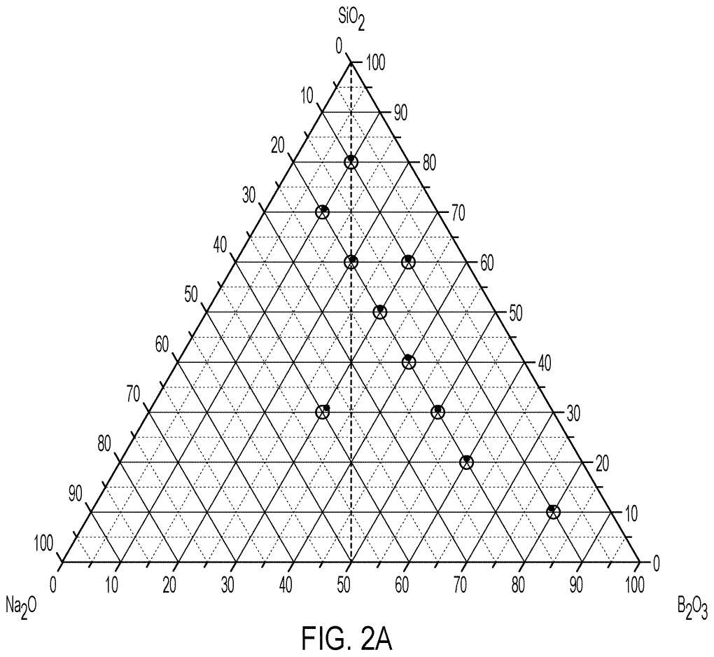

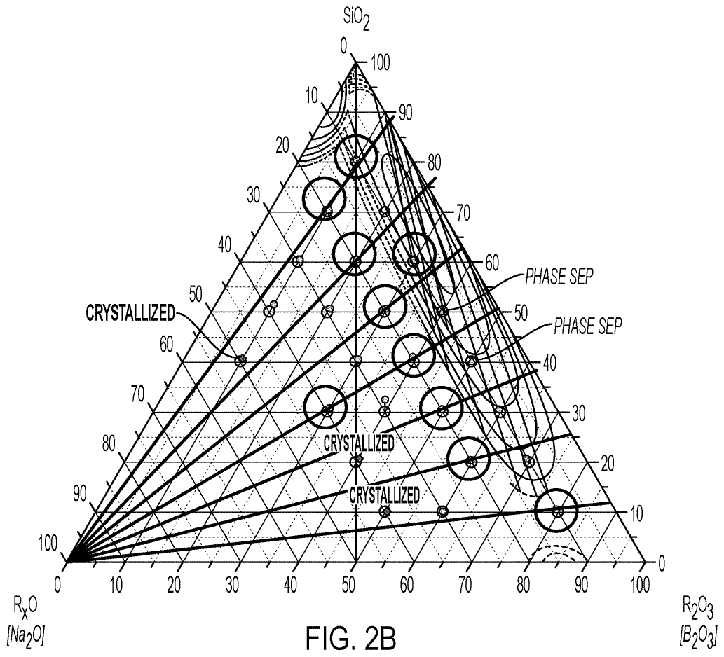

A series of sodium borosilicate glasses were melted, and the compositions verified by inductively coupled plasma optical emission spectrometry (ICP-OES). Bulk composition results are given in Table 1. Table 1 includes the results as measured by ICP-OES (left) and the mapping target values (right) used in the ternary diagrams of FIG. 2A and FIG. 2B.

TABLE 1
Bulk composition information for Examples 1-10.

| | |
|---|---|
| Mol % (ICP-OES) | Mol % (Mapping Target) |

| Ex. | Na₂O | B₂O₃ | SiO₂ | Na₂O | B₂O₃ | SiO₂ |
|---|---|---|---|---|---|---|
| 1 | 9.69 | 10.02 | 80.15 | 10 | 10 | 80 |
| 2 | 9.83 | 29.94 | 60.22 | 10 | 30 | 60 |
| 3 | 10.13 | 79.30 | 10.50 | 10 | 80 | 10 |
| 4 | 19.60 | 10.00 | 70.24 | 20 | 10 | 70 |
| 5 | 19.57 | 20.00 | 60.30 | 20 | 20 | 60 |
| 6 | 19.53 | 29.88 | 50.46 | 20 | 30 | 50 |
| 7 | 19.57 | 39.29 | 41.00 | 20 | 40 | 40 |
| 8 | 19.75 | 49.69 | 30.47 | 20 | 50 | 30 |
| 9 | 19.79 | 59.77 | 20.36 | 20 | 60 | 20 |
| 10 | 39.06 | 30.18 | 30.65 | 40 | 30 | 30 |

A ternary diagram summarizing the precursor glass compositions and the corresponding experimental strategy is shown in FIG. 2A. Model glasses in the Na₂O—B₂O₃—SiO₂ system represent “precursor” or bulk glass compositions, upon which depleted surface layers were synthesized by thermal poling on the positively-biased surface of the glass. After thermal poling, the corresponding compositional effect is to create an alkali-depleted surface layer, wherein the modifier species is driven out of the surface layer. The network-former-only compositions that were generated in the alkali-depleted surface layer are projected onto the B₂O₃—SiO₂ binary edge of the diagram, as shown in FIG. 2B. Unless specified herein, the bulk glass or the alkali-containing bulk glass has the same composition, structure and features as the precursor glass before being subjected to thermal poling.

Use of simple ternary compositions as shown in Table 1 allows for more definitive determination of structure, while still maintaining relevance with commercial and other useful compositions. In addition, the compositions were also selected to provide examples where alkali-depleted surface layers are synthesized with final compositions overlapping one another but formed from precursor glasses of different initial compositions and structure from one another (i.e., to demonstrate that alkali-depleted surface layers having the same compositions can be formed from various precursor glasses). In this way, the role of precursor glass composition could also be probed, with varied concentrations and types of alkali-charge-balanced species in the structure.

Glass sheets were formed from the precursor glass compositions shown in Table 1 and polished into planar coupons having dimensions from about 25 to 50 mm square. The coupons have a thickness of about 1.0 mm.

For thermal poling, a bulk high-purity platinum (Pt) monolith was obtained and polished to an optical finish. This element was placed in contact with the surface of each glass sheet for use as the positively-biased electrode. On the cathode side of each glass sheet, a section of graphite foil (e.g., graphite foil supplied by Graftech International, under the trademark Grafoil®) was used. The electrode sizes were controlled such that they did not cover the entire surface of the glass on either side, to reduce or eliminate leakage currents.

After loosely stacking the electrodes and glass sheet, each such stack was introduced into a vacuum furnace and a dry nitrogen atmosphere was created and heated to a temperature between about 200 °C and 300 °C. After equilibrating at a temperature in this range for about 15 minutes, a voltage of about +300V was applied to the platinum electrode, with current limited to 1 mA maximum. An initial increase in current was observed, followed by a slow decay as the alkali-depleted surface layer formed. The voltage was applied for a period of about 15 minutes, after which the heater was shut off and the stack of electrodes and glass sheet was allowed to cool under voltage. When the temperature of the stack was less than about 100 °C, the voltage was removed, the chamber was vented, and the stack was manually separated.

The glass sheet after thermal poling was compared to the same glass sheet that was unpoled or did not undergo thermal poling for various forms of analysis.

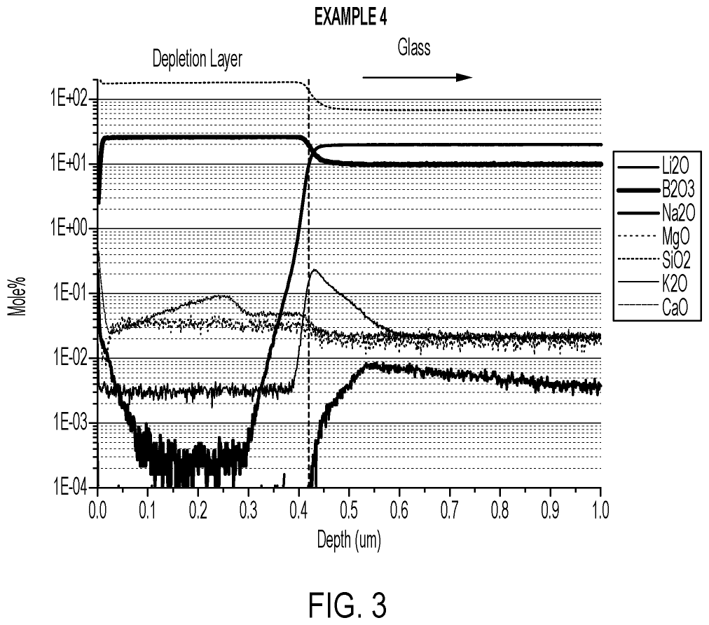

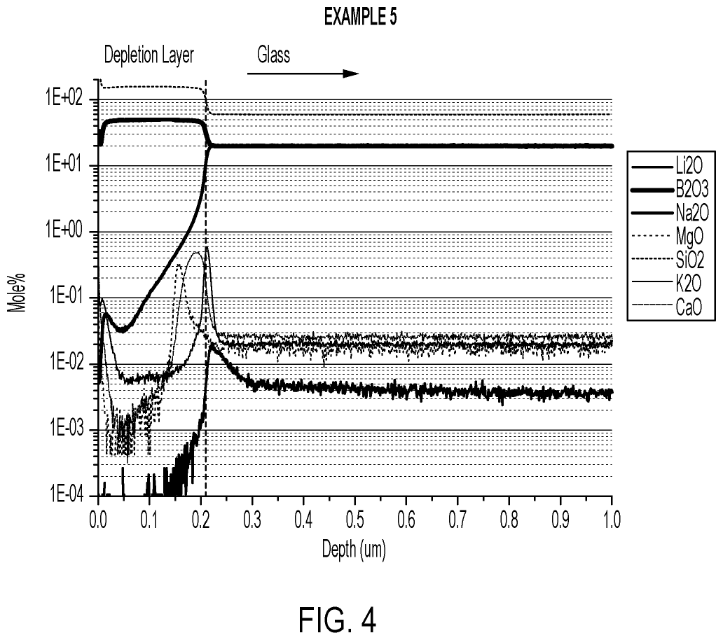

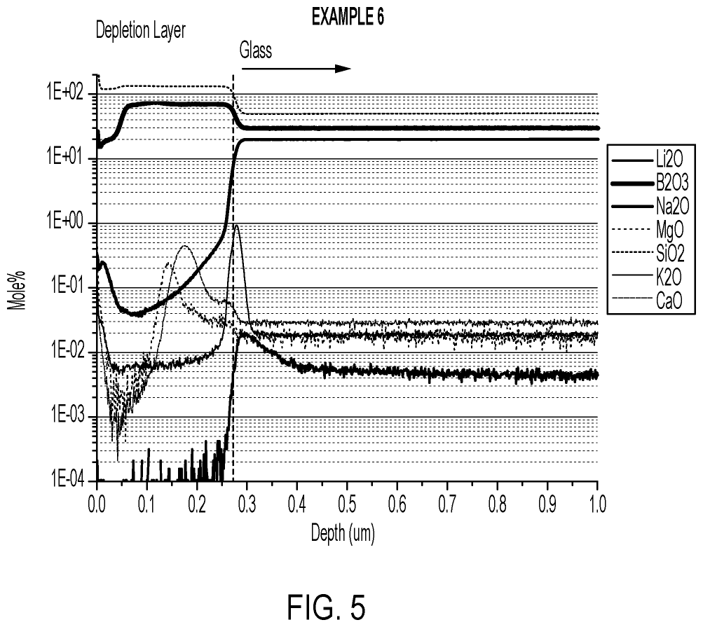

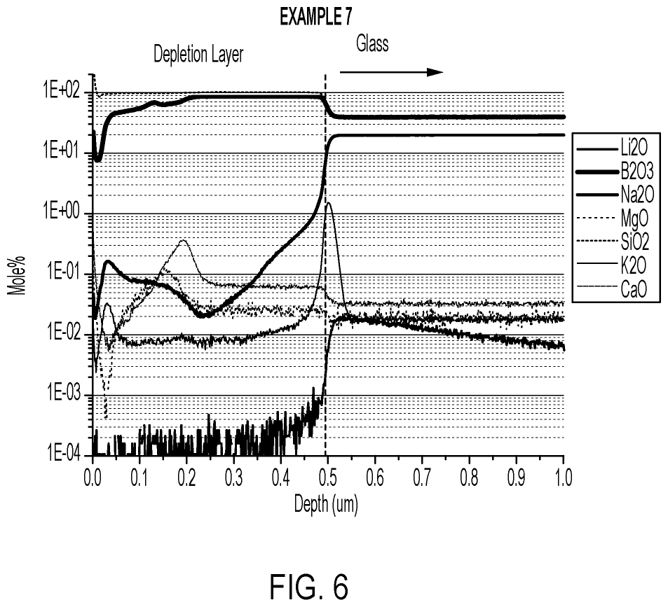

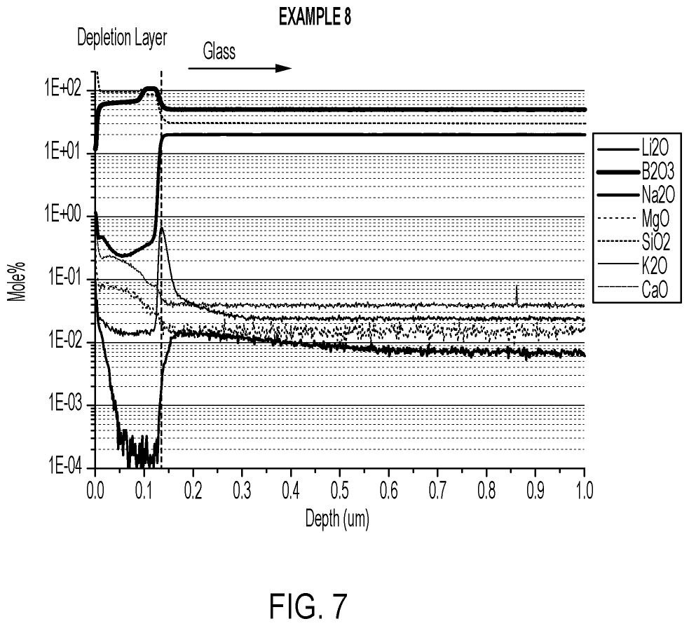

The presence, depth, and composition of the alkali-depleted surface layers and portions of the bulk were evaluated using secondary-ion-mass-spectrometry (SIMS). The results of these analyses for Examples 4-8 of Table 1 are summarized in FIGS. 3-7, respectively. In FIGS. 3-7, the SIMS elemental depth profiles are presented as concentrations of the elements noted in the corresponding legends on the positively biased surface as a function of depth (nm).

FIGS. 3-7 show the creation and presence of alkali-depleted surface layers having a thickness in a range of from about 100 nm to about 500 nm in a wide variety of glass compositions.

X-ray photoelectron spectroscopy (XPS) analyses were performed to evaluate and quantify the composition of the alkali-depleted surface layer to corroborate the SIMS findings. The results are given in Table 2 and are reported as the average of three measurement points per sample.

TABLE 2
XPS data for the surface composition of the
positively-biased surface of select Examples.

XPS concentration (atom %)

| Ex. | State | Na | B | Si | O |
|---|---|---|---|---|---|
| 1 | Poled | 1.5 | 2.5 | 30.5 | 65.2 |
| 2 | Poled | 3.9 | 6.4 | 27.0 | 62.6 |
| 4 | Poled | 0.1 | 2.7 | 31.1 | 66.1 |
| 5 | Poled | 0.0 | 3.9 | 29.6 | 65.9 |
| 6 | Poled | 0.0 | 4.1 | 29.3 | 65.8 |
| 7 | Poled | 0.0 | 2.6 | 29.9 | 66.8 |

Near-edge X-ray absorption fine-structure (NEXAFS) spectroscopy were pursued at a synchrotron facility to probe the structure of the sodium borosilicate poled surface layers of select Examples and understand whether the structures were uniquely differentiated from the precursor glass. Data were acquired in partial-electron-yield (TEY) mode to ensure results were representative of the poled layer structure (i.e., surface-sensitive mode, top 2-5 nm), and were performed primarily at the B K-edge. For detailed procedure, refer to “Boron coordination structure at the surfaces of sodium borosilicate and aluminoborosilicate glasses by B K-edge NEXAFS,” Journal of Non-Crystalline Solids Vol. 545, 1 Oct. 2020, 120247. The primary metric for glass structure extracted from this analysis is the fraction of 4-fold-coordinated boron relative to total boron. This parameter is referred to as N₄=% B[4]/(% B[3]+% B[4])

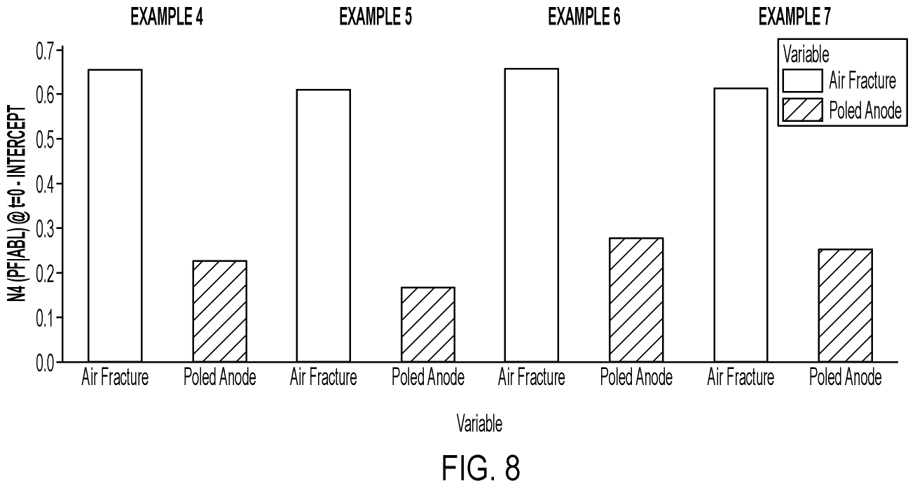

FIG. 8 summarizes the results from the B K-edge NEXAFS analysis, comparing poled anode-side surfaces versus air-fracture surfaces (representing bulk glass structure) for Examples 4-7 after thermal poling. The results indicate that boron shifts to being primarily 3-coordinated in the poled layers (N₄≈0), compared to a much higher N₄ fraction in the parent glass (usually a mix of B[3] and B[4], i.e., N4>0). Without being bound by theory, this change understood from expectations of a B₂O₃—SiO₂ glass composition in the layer that is depleted of Na, and thus there is no alkali available to charge-compensate B in a 4-fold coordinated state. This interpretation assumes—and in fact supports—that the depletion-layer structure resynthesizes in sit/u well below the Tg range of the parent glass to form a unique layer structure and satisfy the bonding requirements of the remaining network-formers in the depletion layer, as discussed in Smith et al, Journal of the American Ceramic Society, 2019. 102(6): p. 3037-3062.

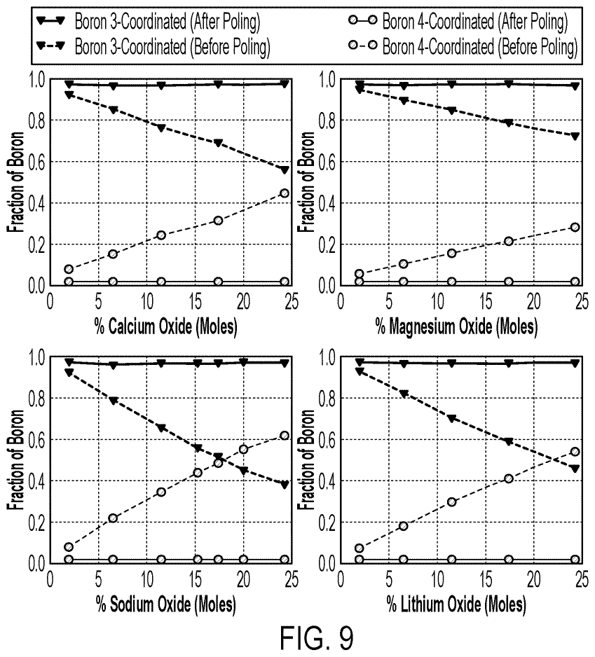

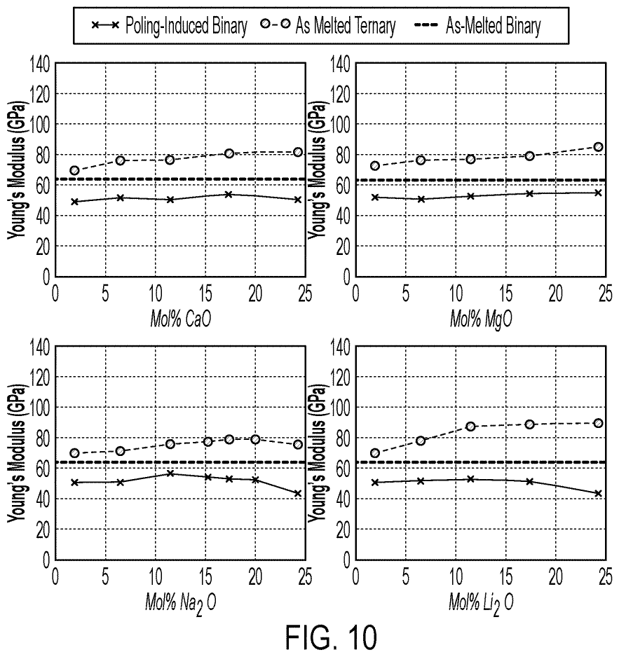

Molecular simulations were performed on a series of alkali and alkaline-earth borosilicate glasses to compare their structures before and after poling. The compositions studied are shown in Table 3 and include Na, K, Mg and Ca-borosilicates. In all the compositions simulated, B₂O₃/SiO₂ ratio of mole fractions were kept constant (i.e. approximately 0.51). In Table 3, M=Na, K, Mg, or Ca, as illustrated in FIG. 9 and FIG. 10

TABLE 3
Precursor Compositions for Molecular Simulations

| SiO₂ | B₂O₃ | B₂O₃/SiO₂ | M₂O or MO |
|---|---|---|---|
| (mol %) | (mol %) | (ratio) | (mol %) |
| 66.28 | 33.72 | 0.51 | 0 |
| 64.98 | 33.06 | 0.51 | 1.96 |
| 61.94 | 31.51 | 0.51 | 6.54 |
| 58.65 | 29.84 | 0.51 | 11.50 |
| 54.78 | 27.87 | 0.51 | 17.36 |
| 50.21 | 25.55 | 0.51 | 24.24 |

FIG. 9 illustrates fraction of boron 3-coordinated (black) and 4-coordinated (red) in the series of alkali and alkaline-earth borosilicate compositions shown in Table 3. As shown in FIG. 9, after thermal poling, there is an observable change in coordination number of boron from a 4-coordinated to 3-coordinated state. FIG. 9 also shows the ratio of B[4] to B[3] conversion increases with network modifiers content because the fraction of B[4] increases with concentration.

Referring to FIG. 10, molecular dynamics simulations show that the change in coordination states also leads to altered Young's modulus. FIG. 10 depicts Young's modulus of sodium borosilicates varying in composition as-melted ternary, as-melted binary, and binary obtained through thermal poling. As shown, the Young's modulus of the alkali-depleted surface laver is generally lower than the bulk.

The results of the molecular simulations help to further establish/Verify the broad applicability of thermal poling to create articles with altered layers when starting with parent glasses that have a wide of range of different modifier species, such as those disclosed herein.

While the disclosure has been illustrated and described in detail in the drawings and foregoing description, the same should be considered as illustrative and not restrictive in character. It is understood that only the preferred embodiments have been presented and that all changes, modifications, and further applications that come within the spirit of the disclosure are desired to be protected.

1. A glass substrate, comprising:
an alkali-containing bulk; and
an alkali-depleted surface layer,
wherein the alkali-depleted surface layer is amorphous and comprises a substantially homogenous composition, and
wherein the alkali-containing bulk and the alkali-depleted surface layer comprise B₂O₃ and SiO₂.

2. The glass substrate of claim 1, wherein the alkali-depleted surface layer comprises about 0.5 atomic % alkali or less.

3. The glass substrate of claim 1, wherein the alkali-depleted surface layer comprises an atomic structure comprising boron substantially in a 3-coordinated state.

4. The glass substrate of claim 3, wherein greater than about 60% by fraction of a total amount of boron in the alkali-depleted surface layer is in a 3-coordinated state.

5.-6. (canceled)

7. The glass substrate of claim 1, wherein the alkali-containing bulk comprises an atomic structure comprising boron in a 3-coordinated state and boron in a 4-coordinated state.

8. The glass substrate of claim 7, wherein greater than about 51% by fraction of a total amount of boron in the alkali-containing bulk is in a 4-coordinated state.

9. The glass substrate of claim 1, wherein the alkali-depleted surface layer is substantially free of non-bridging oxygens.

10.-41. (canceled)

12. The glass substrate of claim 1, wherein the alkali-containing bulk comprises an alkali-metal oxide selected from Li₂O, Na₂O, K₂O, Rb₂O and Cs₂O.

13. The glass substrate of claim 12, wherein the alkali-containing bulk comprises at least 1 mol % Na₂O, K₂O, or Li₂O.

14. The glass substrate of claim 12, wherein the alkali-containing bulk comprises at least 1 mol % Na₂O.

15. The glass substrate of claim 1, wherein the alkali-depleted surface layer comprises B₂O₃ in a range from about 10 mol % to about 90 mol %.

16. The glass substrate of claim 1, wherein the alkali-depleted surface layer comprises a binary B₂O₃—SiO₂ composition.

17. The glass substrate of claim 1, wherein an atomic % silicon is greater than an atomic % boron.

18.-19. (canceled)

20. A method of forming a glass substrate with a modified surface layer, comprising:
providing a glass substrate comprising a concentration of alkali, a glass transition temperature (Tg) and a surface layer, the glass substrate comprising B₂O₃ and SiO₂; and
reducing the concentration of alkali in the surface layer,
wherein the surface layer with the reduced concentration of alkali comprises a substantially homogenous composition.

21. The method of claim 20, wherein an atomic % silicon is greater than an atomic % boron.

22. The method of claim 20, wherein the reducing the concentration of alkali in the surface layer comprises contacting a surface of the glass substrate with an electrode and subjecting the glass substrate to thermal poling.

23. The method of claim 22, wherein the electrode comprises an anode in contact with an anodic surface of the glass substrate and a cathode in contact with a cathodic surface of the glass substrate, and the thermal poling comprises applying voltage to the glass substrate such that the anode is positively biased relative to the glass substrate to induce alkali depletion at the anodic surface of the glass.

24. The method of claim 22, wherein the thermal poling comprises heating the glass substrate and the electrode to a temperature below a Tg of the glass substrate prior to applying voltage to the glass substrate.

25. The method of claim 22, wherein the thermal poling comprises applying a voltage in a range from about 100 volts to about 10,000 volts to the glass substrate for a duration in a range from about 1 minute to about 6 hours.

26. The method of claim 22, wherein the glass substrate is subjected to the thermal poling under vacuum, in an inert gas environment, or in a permeable gas environment.
